(19) United States
(12) Patent Application Publication
(10) Pub. No.: US 2023/0042680 A1
(43) Pub. Date: Feb. 9, 2023

(54) PROCESS FOR THE MANUFACTURE OF HALOGENOBIS(ALKENE)RHODIUM(I) DIMERS OR HALOGENOBIS(ALKENE)IRIDIUM(I) DIMERS

(71) Applicants: Heraeus Deutschland GmbH & Co. KG, Hanau (DE); Heraeus Precious Metals North America LLC, Santa Fe Springs, CA (US)

(72) Inventors: Peter Kettler, Santa Fe Springs, CA (US); Richard Walter, Alzenau (DE); Annika Petri, Hanau (DE)

(21) Appl. No.: 17/444,643

(22) Filed: Aug. 6, 2021

(51) Int. Cl. C07F 15/00

(52) U.S. Cl. CPC C07F 15/0073

(57) ABSTRACT

A process for the manufacture of a complex of the formula [MHal(R¹R²C═CR³R⁴)₂]₂ with M = Rh or Ir; Hal = Cl, Br or l; and R¹R²C═CR³R⁴ = a gaseous mono olefin with 2 to 4 carbon atoms, the process comprising the steps:
(1) preparing an aqueous alcoholic solution of a MHal₃ hydrate salt,
(2) reacting the dissolved MHal₃ hydrate salt with the gaseous mono olefin R¹R²C═CR³R⁴ under formation of precipitated [MHal(R¹R²C═CR³R⁴)₂]₂,
(3) optionally, cooling the reaction mixture obtained after conclusion of step (2) down to a temperature in the range of > 0 to 10° C. and keeping it there, and
(4) collecting and drying the precipitated [MHal(R¹R²C═CR³R⁴)₂]₂,
wherein the temperature of the reaction mixture during step (2) is kept in a range of 15 to 30° C.

The invention relates to an improved process for the manufacture of halogenobis(alkene)rhodium(l) dimers or halogenobis(alkene)iridium(l) dimers.

Chlorobis(ethylene)rhodium(l) dimer or Di-µ-chlorotetrakis(ethylene)dirhodium(l) is the most well-known representative of halogenobis(alkene)rhodium(l) dimers and halogenobis(alkene)iridium(l) dimers. Chlorobis(ethylene)rhodium(l) dimer has the formula:

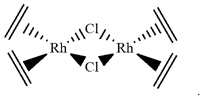

Chlorobis(ethylene)rhodium(l) dimer has been utilized in organic synthesis as a homogenous catalyst often in the presence of specialized ligands. Specific reactions of note include hydrogenation of carbon-carbon double bonds, addition of organometallic reagents to activated alkenes, 1,2-addition of organometallic reagents, the catalysis of addition/cyclization cascades and the decarbonylative coupling of alkenes and arenesulfonyl and aroyl chlorides.

The chlorobis(ethylene)rhodium(l) dimer was first reported in the literature by R. Cramer in 1962, see R. Cramer in Inorganic Chemistry, Vol. 1, No. 3, August, 1962, pages 722 - 723. The chlorobis(ethylene)rhodium(l) dimer can be prepared by treating an aqueous methanolic solution of hydrated rhodium trichloride with ethylene according to the following equation: 2 RhCI₃(H₂O)₃ + 6 C₂H₄ → Rh₂Cl₂(C₂H₄)₄ + 2 CH₃CHO + 4 HCI + 4 H₂O. This prior art synthesis procedure is disclosed in detail in Inorganic Syntheses, Volume XV, McGraw-Hill, Inc., 1974, pages 14 - 16. The yield is reported as 60 - 65% (first crop) or 75 % (combined yield of first crop plus second crop). The first crop is obtained by harvesting and drying the precipitated product and the second crop can be obtained by further treatment of the filtrate with ethylene after neutralization of the filtrate with NaOH.

Object of the invention was to develop a synthesis procedure allowing for a high yield of chlorobis(alkene)rhodium(l) dimers or chlorobis(alkene)iridium(l) dimers and without a need to generate a second crop like in the prior art synthesis procedure. It was also an object to provide a synthesis procedure suitable for scale-up for an industrial process and with a high space time yield.

Unexpectedly and surprisingly, the object can be solved by a process for the manufacture of a complex of the formula [MHal(R¹R²C═CR³R⁴)₂]₂ with M = Rh (rhodium) or Ir (iridium); Hal = Cl (chlorine), Br (bromine) or I (iodine); and R¹R²C═CR³R⁴ = a gaseous mono olefin with 2 to 4 carbon atoms, the process comprising the steps:
(1) preparing an aqueous alcoholic solution of a MHal₃ hydrate salt,
(2) reacting the dissolved MHal₃ hydrate salt with the gaseous mono olefin R¹R²C═CR³R⁴ under formation of precipitated [MHal(R¹R²C═CR³R⁴)₂]₂,
(3) optionally, cooling the reaction mixture obtained after conclusion of step (2) down to a temperature in the range of > 0 to 10° C. and keeping it there, and
(4) collecting and drying the precipitated [MHal(R¹R²C═CR³R⁴)₂]₂, characterized in that the temperature of the reaction mixture during step (2) is kept in a range of 15 to 30° C.

In a preferred embodiment, the precious metal M is Rh and Hal is Cl. In other words, in such preferred embodiment, the process of the invention is a process for the manufacture of a complex of the formula [RhCI(R¹R²C═CR³R⁴)₂]₂.

In a most preferred embodiment, the precious metal M is Rh, Hal is Cl and R¹R²C═CR³R⁴ is ethylene C₂H₄. In other words, in this most preferred embodiment, the process of the invention is a process for the manufacture of [RhCl(C₂H₄)₂]₂.

In step (1) of the process of the invention an aqueous alcoholic solution of a MHal₃ hydrate salt with M = Rh or Ir; and Hal = Cl, Br or I is prepared. Preferably, M denotes Rh and Hal denotes Cl.

It may be expedient, when the purity of the precious metal M or the MHal₃ hydrate salt is of standard reagent grade.

It is expedient to dissolve the MHal₃ hydrate salt in a minimal amount of water, for example, according to a concentration in the range of 2 to 4 mol of precious metal M per liter of aqueous solution, preferably in the range of 2.5 to 3.5 mol of precious metal M per liter of aqueous solution, and to further dilute it with a water-miscible alcohol. The water-miscible alcohol may be selected from methanol, ethanol, isopropanol or any mixture thereof. It is preferred to work with methanol only. It is preferred to introduce the small volume of aqueous MHal₃ hydrate salt solution into the bigger volume of the alcohol solvent.

A typical concentration of the aqueous alcoholic solution prepared in step (1) lies in the range of 0.2 to 0.4 mol of precious metal M per liter of aqueous alcoholic solution, preferably in the range of 0.25 to 0.35 mol of precious metal M per liter of aqueous alcoholic solution.

In step (2) of the process of the invention the dissolved MHal₃ hydrate salt is reacted with a gaseous mono olefin R¹R²C═CR³R⁴ having 2 to 4 carbon atoms under formation of precipitated [MHal(R¹R²C═CR³R⁴)₂]₂.

As becomes apparent from the above, the reaction takes place in aqueous alcohol matrix.

The mono olefin R¹R²C═CR³R⁴ having 2 to 4 carbon atoms is a gas under standard conditions. Examples include ethylene, propylene and any isomer of butylene, with ethylene being the preferred mono olefin.

The mono olefin gas is reacted with the dissolved MHal₃ hydrate salt by simply making contact with each other, i.e. the mono olefin gas is utilized as a reaction atmosphere or, preferably, it is actively bubbled into and through the aqueous alcoholic solution. The mono olefin gas flow rate may be in the range of, for example, 2 to 3 liter per hour and per liter volume of reactor, preferably in the range of 2.5 to 2.75 liter per hour and per liter volume of reactor. There is no need to work under pressure, i.e. step (2) can be performed at normal pressure without making use of an autoclave or the like.

The gaseous mono olefin is supplied in stoichiometric excess amount during step (2). Over the entire step (2) it may be worked with a molar ratio of, for example, 1 mol of precious metal M : > 3 to 10 mol of the mono olefin, typically > 7 to 10 mol of the mono olefin.

It is expedient to stir the reaction mixture during step (2).

It is expedient when step (2) has a duration in the range of 12 to 24 hours, preferably in the range of 15 to 18 hours. A longer reaction time does not result in a remarkably higher yield of [MHal(R¹R²C═CR³R⁴)₂]₂, which precipitates during step (2).

It is essential to keep the temperature of the reaction mixture during step (2) in a range of 15 to 30° C., preferably in a range of 20 to 25° C. Exceeding or undercutting said temperature range has an adverse effect on the yield. Keeping the temperature in said range can be achieved by adequately cooling of the reaction mixture by conventional internal and/or external cooling means. Without such cooling, the temperature of the reaction mixture may rise to 35 to 40° C., for example.

After conclusion of step (2) an optional step (3) may take place, in the course of which the reaction mixture obtained is cooled down to a temperature in the range of > 0 to 10° C. and kept there; i.e. after cooling the reaction mixture to > 0 to 10° C., that temperature is maintained for a period of, for example, 2 to 3 hours.

The > 0 to 10° C. cool reaction mixture may be stirred during such optional step (3) and feeding of the mono olefin gas may be stopped or may preferably be maintained.

After conclusion of step (2) or, as the case may be, after conclusion of optional step (3) a step (4) of collecting and drying the precipitated [MHal(R¹R²C═CR³R⁴)₂]₂ takes place.

The precipitated [MHal(R¹R²C═CR³R⁴)₂]₂ can be collected by any conventional solid-liquid separation procedure like, for example, filtration of the suspension obtained after conclusion of step (2) or of optional step (3) through a Nutsche filtration apparatus or a similar device. The product may be washed with a minimum amount of alcohol solvent before drying it or it may be dried directly. Preferably, drying can be performed at a temperature in the range of 20 to 25° C. in vacuum.

The yield (first crop yield) of [MHal(R¹R²C═CR³R⁴)₂]₂ prepared according to the process of the invention is in the range of, for example, 82 to 87% and thus remarkedly improved compared to that of the prior art process, and this even without having generated a second crop. The purity and quality of the [MHal(R¹R²C═CR³R⁴)₂]₂ obtained is similar to that made according to the prior art procedure.

The process of the invention can be run on an industrial process scale with a high space time yield. For example, 10.5 kg of [RhCl(C₂H₄)₂]₂can be produced from a 200 liter scale reaction. For comparison purposes, if the [RhCl(C₂H₄)₂]₂was scaled d i r e c t l y from the prior art procedure only around 4.8 kg of [RhCl(C₂H₄)₂]₂ would be produced.

### Example 1 (According to the Invention)

In a 4 L beaker equipped with a stir bar and watch glass was charged 1500 ml H2O. The solvent was heated to 70° C. and 1200 g Rh(lll) chloride hydrate were added in portions over 3 hours. After complete addition of Rh(lll) chloride hydrate the solution was heated for an additional hour. The Rh(lll) chloride solution was then allowed to cool and at < 40° C., the solution was filtered through a 1-micron glass membrane to remove any insolubles and the membrane was washed with a minimal amount of water (50 ml).

A separate 22 L reactor was equipped with a mechanical stirrer, gas dispersion tube, gas inlet tube attached to a mineral oil bubbler and thermowell was charged with 12.0 L methanol. With medium agitation the Rh(lll) chloride solution was added to the 22 L reactor and the filter flask was washed with an additional 1200 ml methanol. Ethylene gas was bubbled into the reactor with enough pressure that vigorous bubbling was observed in the mineral oil bubbler. Bubbling of ethylene was continued for 15 h. The reactor was placed in a water bath to maintain the temperature at < 25° C. The rate of ethylene bubbling required adjustment from time to time during the course of the reaction due to uptake of the ethylene and formation of [RhCl(C₂H₄)₂]₂. In total 1020 g of ethylene were bubbled through. After 12 h, the reaction mixture was cooled to < 10° C. At 15 h, ethylene bubbling was ceased, and the product was harvested on a filter plate via vacuum filtration. The product was washed with a minimal amount of methanol (150 ml) and pulled dried on the filter plate for 15-20 min. The [RhCI(C₂H₄)₂]₂ was then transferred to a drying tray and dried to constant weight in a vacuum oven at ambient temperature. The yield was 809.8 g (85% yield). The [RhCI(C₂H₄)₂]₂ was then screened and placed in an appropriate (amber glass) container under inert argon atmosphere. The product container was stored in a refrigerated environment of < 5° C.

### Comparative Example 2

Example 1 was repeated with the only difference that no means for cooling were taken, i.e. the reactor was not placed in a water bath to maintain the temperature at < 25° C. The yield was 638.3 g (67% yield).

As described above, the present invention relates to the following embodiments 1 to 12:

Embodiment 1 relates to a process for the manufacture of a complex of the formula [MHal(R¹R²C═CR³R⁴)₂]₂ with M = Rh or Ir; Hal = Cl, Br or I; and R¹R²C═CR³R⁴ = a gaseous mono olefin with 2 to 4 carbon atoms, the process comprising the steps:
(1) preparing an aqueous alcoholic solution of a MHal₃ hydrate salt,
(2) reacting the dissolved MHal₃ hydrate salt with the gaseous mono olefin R¹R²C═CR³R⁴ under formation of precipitated [MHal(R¹R²C═CR³R⁴)₂]₂,
(3) optionally, cooling the reaction mixture obtained after conclusion of step (2) down to a temperature in the range of > 0 to 10° C. and keeping it there, and
(4) collecting and drying the precipitated [MHal(R¹R²C═CR³R⁴)₂]₂, wherein the temperature of the reaction mixture during step (2) is kept in a range of 15 to 30° C.

Embodiment 2 relates to the process of embodiment 1, wherein the precious metal M is Rh and Hal is Cl.

Embodiment 3 relates to the process of embodiment 1 or 2, wherein R¹R²C═CR³R⁴ is ethylene C₂H₄.

Embodiment 4 relates to the process of any one of the preceding embodiments, wherein during step (1) the MHal₃ hydrate salt is dissolved in water according to a concentration in the range of 2 to 4 mol of precious metal M per liter of aqueous solution and further diluted with a water-miscible alcohol according to a concentration in the range of 0.2 to 0.4 mol of precious metal M per liter of aqueous alcoholic solution.

Embodiment 5 relates to the process of embodiment 4, wherein the water-miscible alcohol is selected from methanol, ethanol, isopropanol or any mixture thereof.

Embodiment 6 relates to the process of embodiment 4 or 5, wherein the water-miscible alcohol is methanol.

Embodiment 7 relates to the process of any one of the preceding embodiments, wherein the mono olefin gas is utilized as a reaction atmosphere or it is actively bubbled into and through the aqueous alcoholic solution.

Embodiment 8 relates to the process of embodiment 7, wherein the mono olefin gas flow rate is in the range of 2 to 3 liter per hour and per liter volume of reactor.

Embodiment 9 relates to the process of any one of the preceding embodiments, wherein the mono olefin is supplied in stoichiometric excess amount during step (2).

Embodiment 10 relates to the process of any one of the preceding embodiments, wherein step (2) has a duration in the range of 12 to 24 hours.

Embodiment 11 relates to the process of any one of the preceding embodiments, wherein the temperature of the reaction mixture during step (2) is kept in a range of 20 to 25° C.

Embodiment 12 relates to the process of any one of the preceding embodiments, wherein step (3) takes place, and wherein the > 0 to 10° C. cool reaction mixture is kept at such temperature for 2 to 3 hours.

1. A process for the manufacture of a complex of the formula [MHal(R¹R²C═CR³R⁴)₂]₂ where M is Rh or Ir; Hal is Cl, Br or I; and R¹R²C═CR³R⁴ is a gaseous mono olefin with 2 to 4 carbon atoms, the process comprising the steps:
(1) preparing an aqueous alcoholic solution of a dissolved MHal3 hydrate salt,
(2) reacting the dissolved MHal3 hydrate salt with the gaseous mono olefin under formation of precipitated [MHal(R¹R²C═CR³R⁴)₂]₂
(3) optionally, cooling the reaction mixture obtained after conclusion of step (2) down to a temperature in the range of > 0 to 10° C., and
(4) collecting and drying the precipitated [MHal(R¹R²C═CR³R⁴)₂]₂
wherein the temperature of the reaction mixture during step (2) is maintained in a range of 15 to 30° C.

2. The process of claim 1, wherein M is Rh and Hal is Cl.

3. The process of claim 1, wherein R¹R²C═CR³R⁴ is ethylene.

4. The process of claim 1, wherein during step (1) the MHal₃ hydrate salt is dissolved in water according to a concentration in a range of 2 to 4 mol of M per liter of aqueous solution and further diluted with a water-miscible alcohol according to a concentration ina range of 0.2 to 0.4 mol of M per liter of aqueous alcoholic solution.

5. The process of claim 4, wherein the water-miscible alcohol is selected from methanol, ethanol, isopropanol or any mixture thereof.

6. The process of claim 4, wherein the water-miscible alcohol is methanol.

7. The process of claim 1, wherein the gaseous mono olefinis utilized as a reaction atmosphere .

8. The process of claim 14, wherein the gaseous mono olefinis bubbled at a flow rate in a range of 2 to 3 liter per hour and per liter volume of reactor.

9. The process of claim 1, wherein the gaseous mono olefin is supplied in stoichiometric excess amount during step (2).

10. The process of claim 1, wherein step (2) has a duration in a range of 12 to 24 hours.

11. The process of claim 1, wherein the temperature of the reaction mixture during step (2) is kept in a range of 20 to 25° C.

12. The process of claim 1, wherein step (3) takes place, and wherein the cooled reaction mixture is maintained at > 0 to 10° C. for 2 to 3 hours.

13. The process of claim 5, wherein the water-miscible alcohol is methanol.

14. The process of claim 1, wherein the gaseous mono olefin is actively bubbled into and through the aqueous alcoholic solution.

15. The process of claim 1, wherein during step (1) the MHal₃ hydrate salt is dissolved in water according to a concentration in a range of 2.5 to 3.5 mol of M per liter of aqueous solution and further diluted with a water-miscible alcohol according to a concentration in a range of 0.25 to 0.35 mol of M per liter of aqueous alcoholic solution.

16. The process of claim 1, wherein step (2) has a duration in a range of 15 to 18 hours.

17. A process for the manufacture of a complex of the formula [MHal(R¹R²C═CR³R⁴)₂]₂ where M is Rh or Ir; Hal is Cl, Br or I; and R¹R²C═CR³R⁴ is a gaseous mono olefin with 2 to 4 carbon atoms, the process comprising:
(1) preparing an aqueous alcoholic solution of a dissolved MHal3 hydrate salt,
(2) reacting the dissolved MHal3 hydrate salt with the gaseous mono olefin under formation of precipitated [MHal(R¹R²C═CR³R⁴)₂]₂,
(3) cooling the reaction mixture obtained after conclusion of step (2) down to a temperature in a range of > 0 to 10° C., and
(4) collecting and drying the precipitated [MHal(R¹R²C═CR³R⁴)₂]₂,
wherein the temperature of the reaction mixture during step (2) is kept in a range of 15 to 30° C.

18. The process of claim 17, wherein [MHal(R¹R²C═CR³R⁴)₂]₂ is [RhCl(C₂H₄)₂]₂.

19. The process of claim 17, wherein step (3) is performed while stirring.

20. The process of claim 17, wherein step (3) is performed while feeding the gaseous mono olefin to the cooling reaction mixture.
